(19) United States
(12) Patent Application Publication
(10) Pub. No.: US 2004/0057543 A1
(43) Pub. Date: Mar. 25, 2004

(54) Synchronizing radio units in a main-remote radio base station and in a hybrid radio base station

(76) Inventors: Arie Huijgen, Apeldoorn (NL); Andreas Zell, Nurnberg (DE)

Correspondence Address: NIXON & VANDERHYE P.C., 8th Floor, 1100 North Glebe Road, Arlington, VA, 22201, US

(21) Appl. No.: 10/252,827

(22) Filed: Sep. 24, 2002

(51) Int. Cl. H04L 7/00

(52) U.S. Cl. 375/356

(57) ABSTRACT

A main-remote radio base station system includes plural remote radio units each having a remote digital interface unit and a main unit having a main digital interface unit. Different length links couple different remote radio units to the main unit. The digital interfaces in the main and remote units include a digital data channel and a digital timing channel. A delay associated with each link is determined without interrupting transmission of data over the digital data channel. The delays, reported continuously, periodically, or upon request, are compensated for and equalized by advancing a time when the timing and data signals are sent over their respective digital channels. In a preferred embodiment, the interface is a digital optical interface. A hybrid base station includes synchronized “near” and “remote” radio units.

### FIELD OF THE INVENTION

The present invention is directed to radio communications where a base station includes a main base band processing unit and plural radio remote units where RF processing occurs. The invention synchronizes the radio remote units coupled to a main unit with different length links. Such links may be realized in one example implementation using optical technology. The invention also synchronizes near and remote radio units in a hybrid base station.

### BACKGROUND AND SUMMARY OF THE INVENTION

A conventional radio base station in a cellular communications system is generally located in a single location, and the distance between the baseband circuitry and the radio circuitry antenna is relatively short, e.g., on the order of one meter. A distributed base station design, referred to as a main-remote design, splits the baseband part and the radio part of the base station. The main unit (MU) performs base band signal processing, and one or more radio remote units (RRUs) converts between baseband and radio frequencies and transmits and receives signals over one or more antennas. Each RRU serves a certain geographic area or cell. A corresponding optical link connects the main unit to each of plural radio remote units. Each optical link may include, for example, one optical fiber for carrying digital information downlink from the main unit to the RRU, and another optical fiber for carrying digital information uplink from the RRU to the main unit.

An analog modulated optical link requires higher dynamic range than a digital link. An analog link is more sensitive and limited by noise in the transmitter and receiver, linearity of the transmitter, distortion in the receiver, reflections along the link due to poor connectors, etc. These limitations put a limit on the maximum optical link distance, and repeaters are not much help because they add even more noise. In contrast, digital optical links permit the main unit and the radio remote units to be located more than 10 kilometers apart. Indeed, very large distances (e.g., 100's of kilometers) may be achieved by using digital optical repeaters. Digital optical transmission eases the reuse of existing optical fiber infrastructure that may not have sufficient quality to support analog optical transmission.

FIG. 1 shows an example of a main-remote base station system at reference numeral 10. The main unit 12 includes radio base station baseband (BB) functionality 14. A first optical link L1 couples the main unit 12 to a first radio remote unit 16a. A second, longer optical link L2 couples the main unit 12 to a second radio remote unit 16b. A third, even longer optical link L3 couples the main unit 12 to a third radio remote unit 16c. Of course, additional radio remote units could be coupled to the main unit 12. A mobile radio user equipment (UE) 18 and one or more of the radio remote units 16a-16c communicate over a radio interface.

Some mobile communication standards, as e.g. the code division multiple access (CDMA) cellular system, permits a UE to communicate with two or more RRUs of the same base station using “softer handover” where two or more RRUs simultaneously transmit the same information to the UE and receive the same information from the UE. The simultaneously transmitted signals must be processed to generate a single signal. Some radio standards require that in the downlink direction, the signals simultaneously transmitted to the UE from different antennas be aligned with a timing reference at the antennas. That alignment makes combining those different signals easier on the receiver. In the uplink direction, the main unit base band functionality 14 includes a rake receiver which combines the “same” signals received from the UE via the RRUs and generates a single signal. Because of differing path lengths, these signal components received at the main unit base band functionality 14 from different radio remote units are not time and phase aligned to each other. Although a rake receiver can combine out-of-phase signals from different signal paths, a less complicated and less expensive rake receiver may be used if the phase/delay differences between different signal paths are kept small.

In a main-remote radio base station, a larger part of the phase or timing difference may be attributed to the different lengths of the optical links coupling different RRUs to the main unit 12 as compared to a conventional base station. Different optical link delays are more problematic as the distance between the remote unit 16 and the main unit increases, e.g., 10 kilometers. In addition, such delays are not constant and may vary depending on temperature and other factors. Without compensation, the different link lengths to the remote units result in a time and phase shift of the signals sent out from the antennas connected to the radio remote units. They also lead to larger time/phase shifts between the UE signal components received via different radio remote units. These time/phase shifts may be difficult for conventional receivers in the UE and in the base station to handle. A similar problem exists in a hybrid base station that incorporates both conventional near radio units and remote radio units. The near radio units, which do not have any optical link delays, are not synchronized with the remote radio units that do have link delays.

It is an object of the present invention to synchronize distributed radio remote units coupled to a main base station unit via different length links.

It is an object to measure and compensate for time delay differences associated with different links.

It is a further object to continuously, periodically, or on request automatically update a delay compensation for each link to account for temperature changes and other factors that may affect the delay over the link.

It is an object to perform delay measurements and updates without having to interrupt transmission of data.

It is still another object to provide delay measurement and compensation for remote radio units configured in different network topologies.

It is an object to modify conventional base station timing so that main-remote base stations can be used compatibly in conventional mobile communications networks.

It is an object to synchronize near and remote radio units in a hybrid base station.

The present invention solves the problems identified above and satisfies the stated and other objects. A main-remote radio base station system includes plural remote radio units each having a remote digital interface unit and a main unit having a main digital optical interface unit. Both units support a digital interface with a digital data channel, a digital timing channel, and a digital control channel. A two-way link couples one of the remote radio units and the main unit. Different length links have different delay times.

The main digital interface unit includes for each remote radio unit a delay detector and a timing compensator. The delay detector determines the delay associated with that remote radio unit's link without interrupting transmission of data over the one or more digital data channels. The delay detectors automatically report the delays to a timing compensator controller in the main unit either continuously, periodically, or upon request.

Each timing compensator compensates for the delay associated with its remote radio unit's optical link by adding a delay for both directions of one or more links so that the delay is the same for all links. Each compensator sends a timing signal and a downlink data signal over respective channels in advance of the time when they would be sent without any link delay, i.e., in a conventional base station. That time is often marked by a timing reference like a frame synchronization signal. As a result of length equalization for the downlink direction and the associated advanced transmission, the data signal is received at each of the remote radio units at substantially the same time as in conventional radio base stations with only near radio units, despite the different delays associated with each remote radio unit's link. The advanced-in-time transmission together with length equalization for the uplink direction also ensures that a response to the digital data signal sent by each of the remote radio units is received in the main unit at substantially the same time, despite the different delays associated with each remote radio unit's link.

Based on the delays received from the delay detectors, the timing compensation controller selects a maximum delay. In an example embodiment, that delay corresponds to the delay associated with the longest remote radio unit link An advanced transmit time is determined for each remote radio unit based on the maximum link delay. In a specific example embodiment, the transmission time of the digital timing and data signals is advanced by twice the maximum link delay.

The main digital interface unit includes for each remote radio unit a transmit buffer and a receive buffer. The timing compensation controller sets the transmit buffering time that the data signal is stored in the transmit buffer before the data signal is sent on the one or more digital data channels. A responsive data signal from the remote digital interface unit is stored in the receive buffer for a receive buffering time. The sum of the transmit buffering time or receive buffering time and the measured delay for the link equals the maximum delay.

Delay differences associated with optical links on the order of meters up to 100 kilometers or more can be compensated. The link delay compensation may be used in any main-remote radio unit network configuration including, for example, tree, cascade, ring, star, and mesh configurations.

Another aspect of the invention relates to a hybrid radio base station. The base station includes baseband processing circuitry and plural near radio units. Remote radio units are coupled by different length links to the base station. Digital interface units couple each near and remote radio unit to the baseband processing circuitry. Each near radio unit digital interface and each remote radio unit digital interface includes a timing compensator for compensating for a delay associated with its corresponding radio unit so that a signal received by one of the near radio units and the same signal received by one of the remote radio units may be synchronized for processing in the baseband processing circuitry. Even though the near radio units do not have any link delay because they are “near” units, signals sent to or received from the near units must be delayed by the maximum link delay which is determined in accordance with the longest remote radio unit link. Synchronizing signals received by both near and remote radio units facilitate softer handover in the baseband receiver.

### BRIEF DESCRIPTION OF THE DRAWINGS

The foregoing and other objects, features, and advantages of the present invention may be more readily understood with reference to the following description taken in conjunction with the accompanying drawings.

FIG. 1 illustrates an example of a main-remote radio base station system;

FIG. 2 illustrates in function block form a main unit and a radio remote unit from the main-remote radio base station system;

FIG. 3 illustrates in function block form the optical baseband interface of the radio remote unit in the main-remote radio base station system;

FIG. 4 illustrates in function block form the optical baseband interface of the main unit in the main-remote base station system;

FIG. 5 is a flowchart diagram illustrating procedures for digital optical interface link delay measurement and compensation in accordance with one example embodiment of the present invention;

FIG. 6 illustrates digital optical interface link delay measurement in accordance with one example aspect of the invention;

FIG. 7 shows a timing diagram illustrating an example of delay equalization for a main unit-three remote unit configuration;

FIG. 8 shows timing diagrams to illustrate certain aspects of the digital optical interface link delay compensation in accordance with one example aspect of the invention;

FIGS. 9A-9E illustrate various main-remote radio base station network configurations; and

FIG. 10 illustrates in function block form a hybrid base station.

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details. For example, while the present invention is described in an example application to a CDMA-based cellular system, the present invention may be used in any cellular system employing a main-remote radio base station architecture having any number of remote units configured in any network topology. It may also be used in any cellular system employing a hybrid base station.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

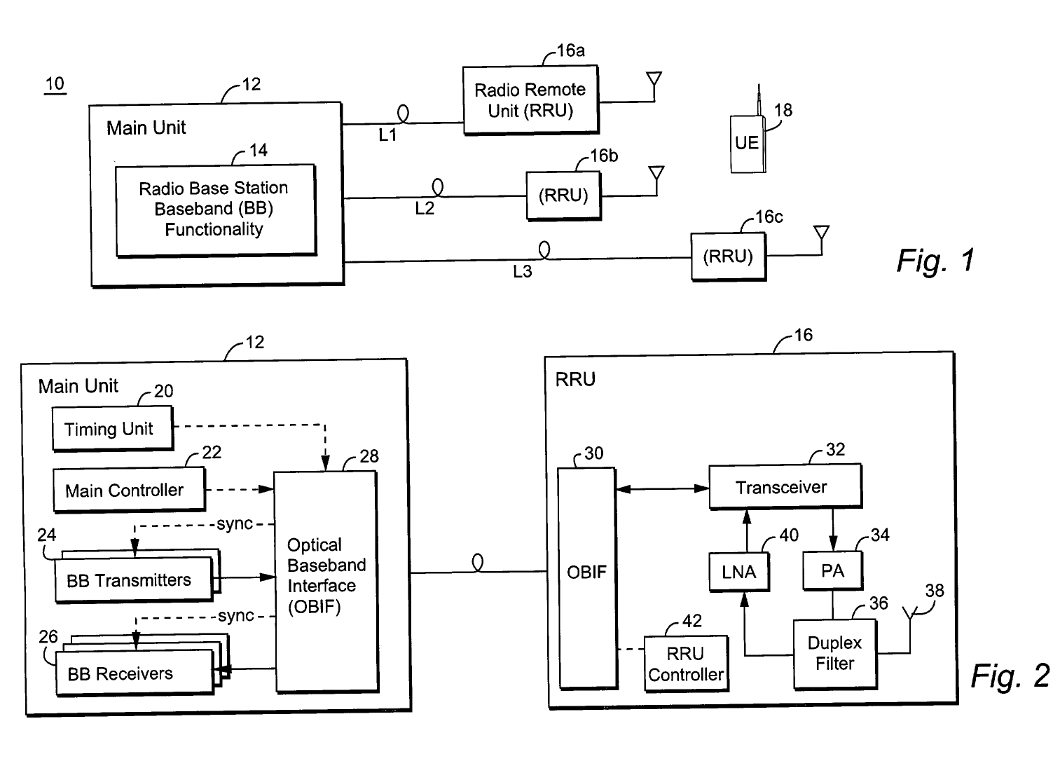

The present invention finds advantageous, but still example, application to a CDMA mobile communications network that supports softer handover. In this example application, one or more external networks is coupled to a CDMA-based radio access network which, for example, may be a UMTS Terrestrial Radio Access Network (UTRAN). The UTRAN includes one or more radio network controllers (RNC) which communicate over a suitable interface, and each RNC is coupled to plural radio base stations. One or more the radio base stations may be configured as a main-remote base station system such as is shown in FIG. 1 where different remote radio units (RRUs) 16 are coupled to a main unit 12 via different length links L1-L3. Any suitable type of transmission link may be used. In the example, non-limiting embodiment, the links are optical and are sometimes referred to as Optical Interface Links (OILs). Each optical link may include a downlink optical fiber for transmissions from the main unit to the RRU and an uplink optical fiber for transmissions from the RRU to the main unit. However, a single fiber could be used.

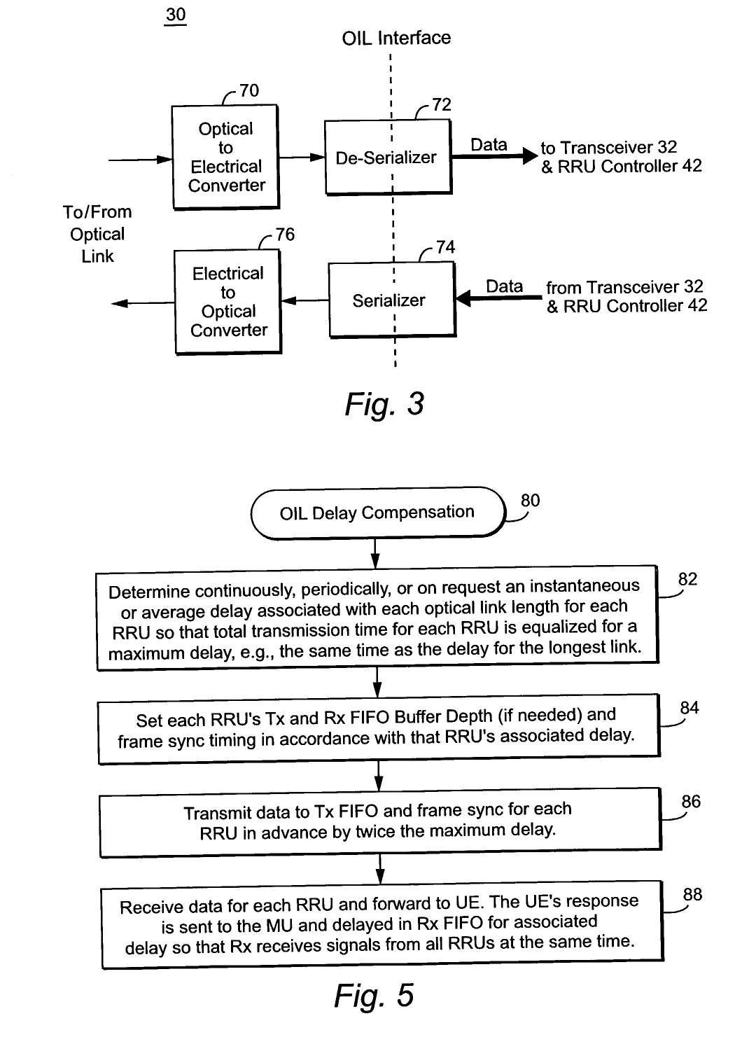

FIG. 2 illustrates in function block form the main unit 12 coupled to one RRU 16. A digital optical interface sometimes referred to below as an Optical Interface Link (OIL) interface is used to provide digital communications between the main unit 12 and the RRU 16. The main unit includes an optical baseband interface (OBIF) unit 28, and the RRU 16 includes an optical baseband interface (OBIF) unit 30. The OBIF 28 and 30 support the digital optical interface. On one side of the digital optical interface parallel digital channels for data signals, timing signals, and control signals are provided. On the other side, that digital information is converted into a serial stream of optical signals. As an example, a 16-bit wide digital optical interface includes 16 parallel digital channels.

The main unit 12 includes a timing unit 20 that generates one or more timing signals such as a frame synchronization (FS) signal which is provided to the OBIF 28 as a digital timing channel corresponding to one or more bits in the OIL interface. A main unit controller 22 generates control signals provided to the OBIF 28 over a digital control channel corresponding to one or more bits in the OIL interface. One or more baseband transmitters 24 provide digital data to the OBIF 28 over one or more digital channels corresponding to one or more bits in the OIL interface. One or more baseband receivers 26 receive digital data sent by the RRU 16. The timing reference for the baseband transceiving circuitry may be generated in any appropriate manner. In one example, a timing signal, e.g., a frame synchronization signal provided from the OBIF 28, may be used for the baseband transmitters 24 and for the baseband receivers 26. However, the timing signals for the transmitters and receivers need not be identical, e.g., they could be altogether different or they may be shifted relative to each other.

The RRU 16 has a similar (though not identical) OBIF 30 coupled to a transceiver 32 and to an RRU controller 42. The RRU controller 42 receives and sends control signals over the digital control channel. The transceiver 32 receives and sends digital data from/to the OBIF 30. The received data is processed, modulated, filtered, frequency up-converted, and amplified in a power amplifier 34 before being transmitted over an antenna to a mobile radio UE 18 byway of a duplex filter 36. UE radio signals received from the antenna 38 and duplex-filtered at 36 are amplified in a low noise amplifier 40 and similarly handled in transceiver 32 but in complementary fashion.

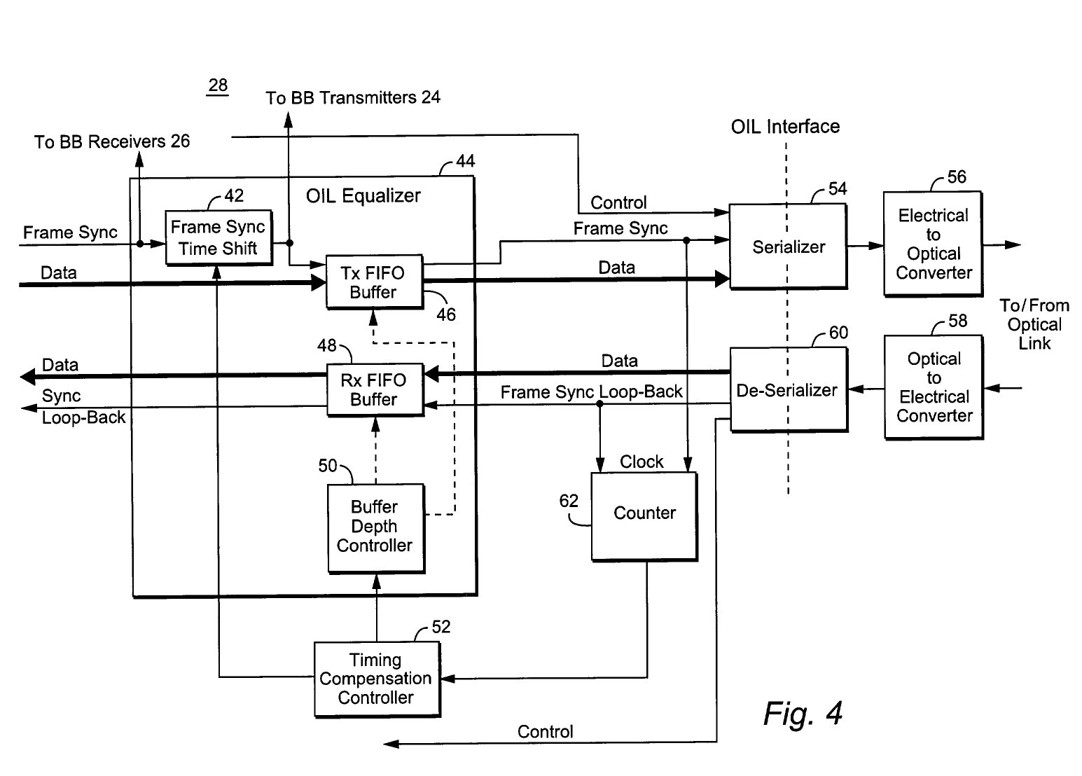

FIG. 3 illustrates further details of the OBIF 30 in each RRU 16. An optical signal transmitted over the optical link from the main unit 12 is converted into a serial digital electrical signal in an optical-to-electrical converter 70 such as a PIN diode. The serial digital signal is converted into a parallel digital signal in a de-serializer 72. The parallel signal sent to the transceiver 32 and the RRU controller 42 includes the digital data, timing, and control channel signals. In the other direction, parallel digital data, control, and timing bits are transformed into a serial stream by a serializer 74. An electrical-to-optical converter 76 converts the digital stream into an optical signal sent over an optical fiber to the main unit 12. An example of an electrical-to-optical converter is a laser diode.

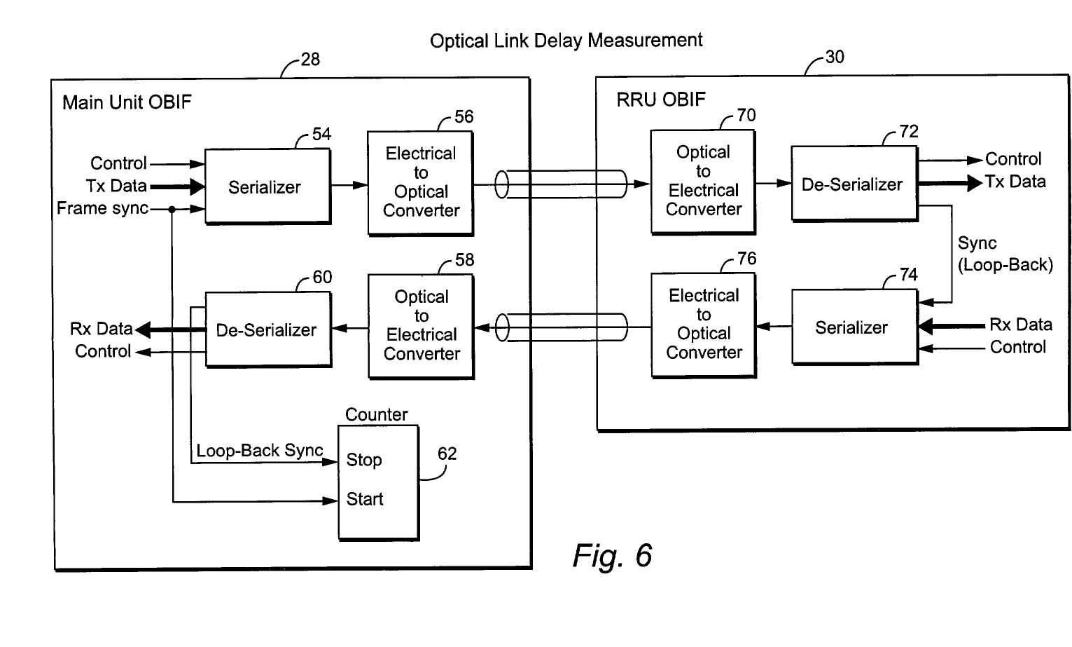

FIG. 4 illustrates further details of the OBIF 28 in the main unit 12 for one of the RRUs to simplify the explanation. The control signaling relates only to the RRU and does not require any OIL equalization. The OBIF 28 includes similar details for each RRU connected to it. An optical signal received over the optical link from an RRU 16 is converted into a serial digital electrical signal in an optical-to-electrical converter 58 such as a PIN diode. The serial digital signal is converted into a parallel digital signal in a de-serializer 60. The parallel signal sent to an OIL equalizer 44 includes the digital data and timing channel signals. The digital control channel signal is sent to a main unit processor (not shown). In the other direction, parallel digital data, control, and timing channel bits are transformed into a serial stream by a serializer 54. The main unit processor provides the digital control signal, and the OIL equalizer 44 provides the digital data and timing signals. An electrical-to-optical converter 56 converts the digital stream into an optical signal sent over an optical fiber to a corresponding RRU 16. An example electrical-to-optical converter is a laser diode.

In the example embodiment, the OIL equalizer 44 includes a time shifter 42, a transmission buffer 46, a receive buffer 48, and a buffer depth controller 50. The transmission buffer 46 is a first-in-first-out (FIFO) buffer that receives data from the baseband transmitter 24. The data is stored for a time period corresponding to the FIFO's buffer depth before being output on the data channel to the serializer 54. The FIFO buffer depth is controlled by the buffer depth controller 50. In this example implementation, the timing reference comes from a frame synchronization signal. The frame sync is sent to the base band receivers (unshifted in time) and to the time shifter 42. The time shifter 42 advances the frame sync signal by a predetermined time interval, (described below), and sends the time-advanced frame sync to the transmission FIFO buffer 46. The frame sync is delayed in the FIFO buffer 46 along with the data to preserve the timing relationship between the frame sync and the data. The shifted frame sync is used by the base band transmitters 24 for early transmission of the downlink data as described further below. The unshifted frame sync is sent to the base band receivers as a timing reference.

Rather than advance the downlink timing reference signal by a predetermined amount as above, another example approach is to delay the uplink timing reference signal by the predetermined amount. This latter approach does not require shifting of the frame sync signal in the downlink path but in the uplink path. Still another example approach does not rely on or affect the frame sync, but instead the transmit timing is advanced by a software setting in the transmitter.

The OIL equalizer 44 also includes a receive FIFO buffer 48 that receives digital data and a “looped back” frame sync signal from the de-serializer 60. The data and frame sync are stored for a time period corresponding to the FIFO's buffer depth and controlled by the buffer depth controller 50, before outputting the data and frame sync on the data channel and timing channels, respectively. The FIFO data and frame sync are sent to the baseband receiver 26.

At the same time the frame sync signal is sent to the serializer 54, it is also sent to start a counter 62. The counter 62 counts, using a clock or other appropriate signal, until it is stopped by receipt of the looped back frame sync signal from the de-serializer 60. The count value, corresponding to the measured delay of the optical link, is provided to the timing compensation controller 52. The timing compensation controller 52 receives similar delay count values for the other RRUs and determines a maximum delay value. As one example, the timing compensation controller 52 may select the largest count value as the maximum delay value. The timing compensation controller 52 sends twice the maximum delay value to the time shifter 42 to provide the advanced time reference when the data and frame sync should be sent to the transmission buffer 46. The timing compensation controller 52 uses the difference between the maximum delay and the measured delay value for each RRU's optical link to determine the FIFO buffer depth sent to the buffer depth controller 50.

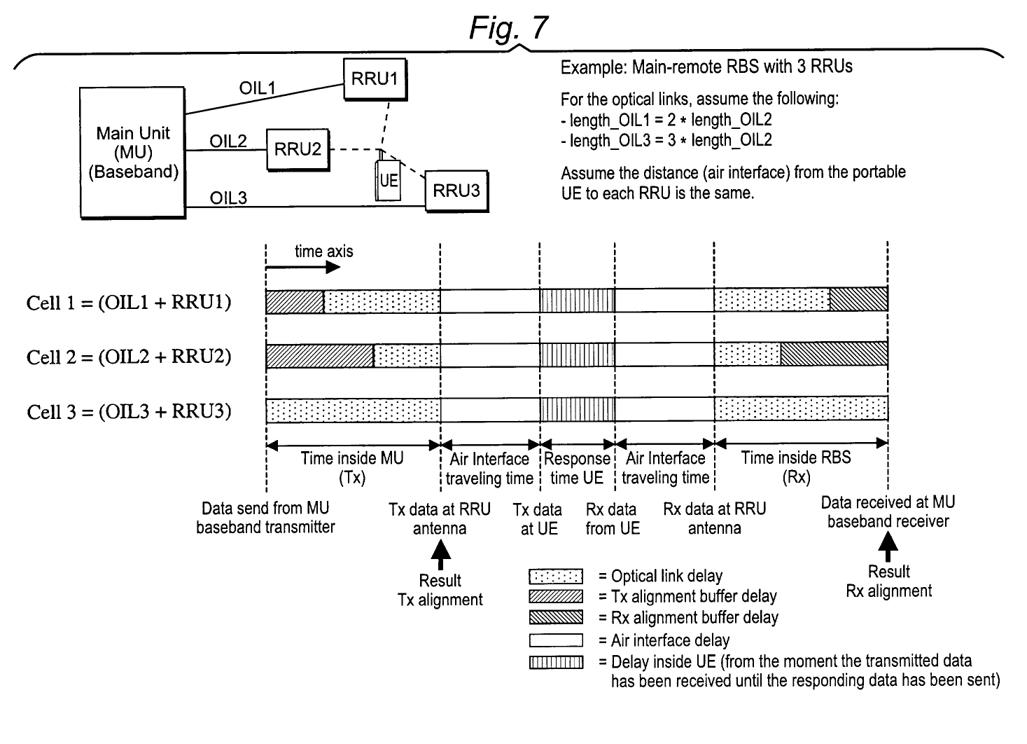

Example OIL Delay Compensation procedures (block 80) are described in conjunction with the flowchart in FIG. 5. Starting with block 82, the timing compensation controller 52 determines, using the counter 62 outputs for each RRU, an instantaneous or average time delay associated with its optical link length. That delay determination may (if desired) be performed continuously, periodically, or on request from the timing compensation controller 52. In general, the timing compensation controller 52 uses the reported delays to calculate an individual additional delay for each OIL link to equalize the overall transmission times for each RRU. The additional delay is introduced into the transmission chain using the transmission FIFO buffer 46 and the receive FIFO buffer 48. For example, the overall delay of transmitted signals for all of the RRUs can be equalized to the RRU delay time that is the longest. The longest RRU delay time of all the OIL links may be the “maximum delay” or some larger delay time if desired.

In block 84, the difference between the maximum delay time and the RRU's associated delay is used to determine each RRU's transmission and receiver FIFO buffer depths and frame sync advance timing. For the RRU associated with the longest delay, if the maximum delay equals that longest delay, the FIFO delay is zero. For RRUs wih OIL link delays shorter than the maximum link delay, the additional delay caused by each transmission FIFO buffer and receive FIFO buffer is selected so that the total FIFO buffer delay together with the OIL link delay equals the maximum link delay. For all of the RRUs, the main unit sends the data “early” from the time they would otherwise be transmitted if there was no delay associated with the optical links (block 86). In a preferred example embodiment, the advance timing is twice the maximum link delay. Each RRU receives that information from the main unit and forwards the information to the mobile radio UE. The RRU sends the response from the UE to the main unit where it is delayed in the receive FIFO for a time corresponding to the set FIFO buffer depth (block 88).

The advanced and synchronized timing benefits both the UE and the base station baseband receivers. The data from the main unit is transmitted from plural RRUs having different length/delay optical links at the same time. This allows the UE baseband receiver to more easily process the plural signals without being affected by different optical link delays. Similarly, the timing of the response data from the UE forwarded by the plural RRUs over different length/delay optical links, which is provided from the receive FIFOs to the baseband receiver in the main unit, is not affected by the different lengths of the optical links. The main unit baseband receiver can therefore more easily process the plural signals without being affected by different optical link delays. These benefits enable softer handover in a CDMA-based cellular communications system without requiring a more complex RAKE receiver. A typical CDMA receiver is designed to handle a certain delay difference between signal components received from different antennas (for example when in softer handover) and/or via different propagation paths. This design is not made for the additional delay difference introduced by the different OIL link lengths in a main-remote base station. The invention aligns the timing of the different antennas, and preferably, the overall timing in the base station so that such a typical receiver can be used.

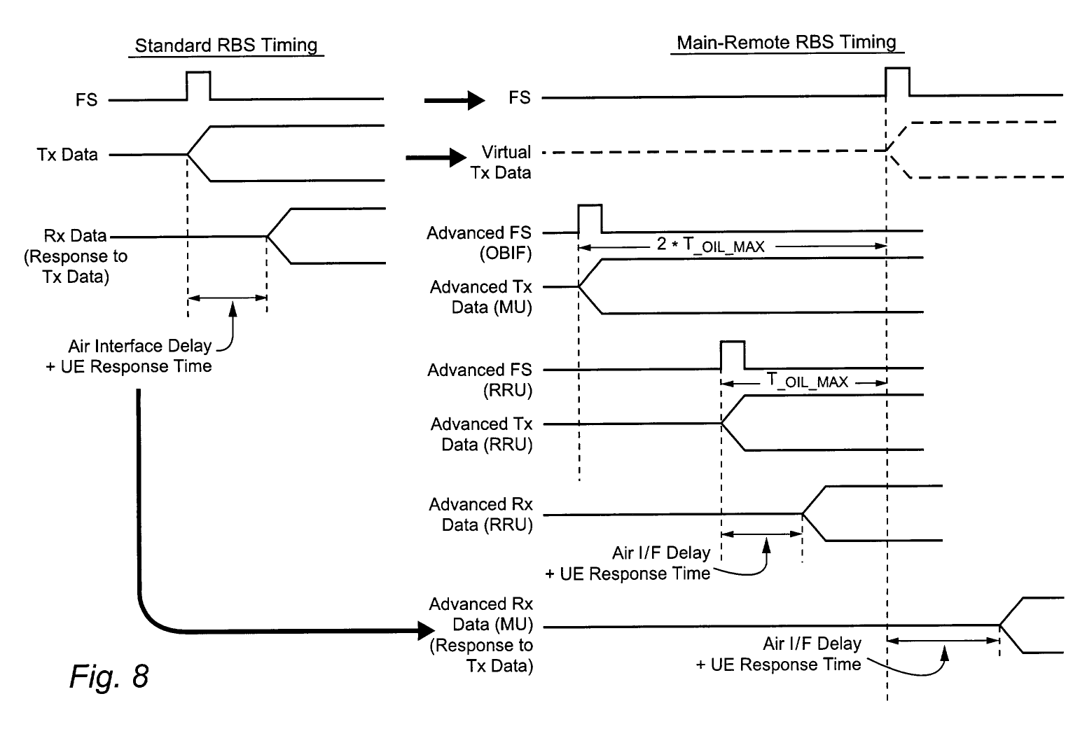

The optical link delay measurement is illustrated conceptually in FIG. 6 for a single main unit/remote radio unit link. The same measurement process may be used for all of the main unit/remote radio unit links. The frame sync pulse in the main unit OBIF 28 starts the timer 62. At the same time, the frame sync pulse is transmitted over one of the fibers in the optical link to the RRU OBIF 30 where the de-serializer 72 “loops it back.” Delays over the air interface and in the UE must not be measured. The serializer 74 returns the looped back frame sync over another fiber in the optical link to the main unit OBIF 28 where it stops the counter. The delay time required to loop the sync pulse back is reflected in the count value and is forwarded to the timing compensation controller 52 (see FIG. 4). Although another timing signal could be used or even generated to perform this task, using the already-available frame sync pulse generated by the main unit requires no additional overhead or expense.

By having the frame sync communicated on its own digital timing channel, the delay measurement does not interrupt the transmission of data over the digital channel. Moreover, the delay measurement may take place continuously, periodically/at regular intervals, or upon request by the timing compensation controller 52. Indeed, the delay caused by each optical link may change depending on certain factors. One factor is changing temperature. The independent (i.e., from the data channel) and ongoing delay measurement capability ensures that the timing compensation controller 52 has up-to-date and accurate delay measurements. The accurate delay measurements means that the delay compensation based on those measurements is also accurate.

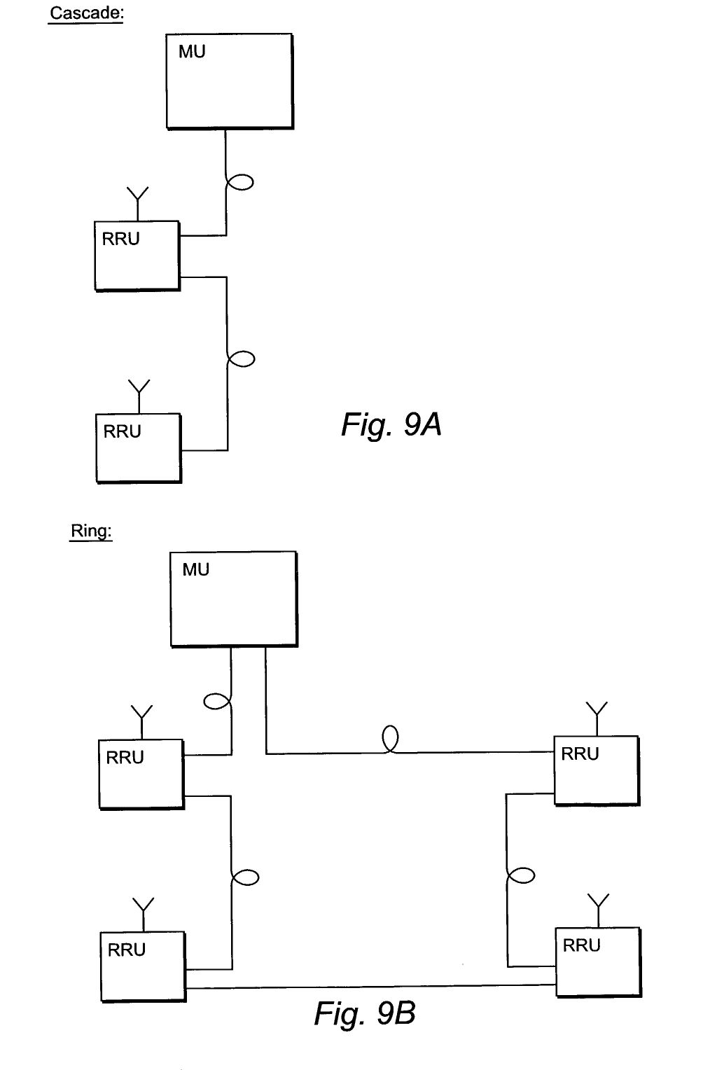

To determine the FIFO buffer depths for each RRU, the timing compensation controller 52 calculates from the optical link delays reported for each RRU the associated one-way delay for each optical link and selects a maximum delay. In the following example shown in FIG. 7, the selected common delay is set equal to the longest calculated one-way delay. Each RRU has its own cell and a different length optical link: OIL1, OIL2, and OIL3. The length of OIL1 is 2* OIL2. The length of OIL3 is 3* OIL2. The delay information for RRU1 and RRU2 must be compensated so that the delays associated with OIL1 and OIL2 equal the delay associated with OIL3, which is the maximum delay in this example. The UE is assumed to be equidistant from each of the 3 RRUs over the air interface, which is not required but simplifies the example.

As described above, the main unit baseband transmitter data intended for the UE is sent to each transmit (TX) FIFO 46 in the main unit OIL equalizer 44 ahead of schedule by twice the maximum link delay. Here, the timing schedule is determined by the frame sync (FS) generated by the timing unit 20 and advanced by the time shifter 42. The goal is to transmit that data to each of the three FIFOs ahead of time so that after traversing their three respective transmit FIFO buffers and OIL links, the data is received at their respective RRUs at the same time. So the data to be sent to RRU1 is delayed in its TX FIFO buffer for a transmit alignment delay. The data to be sent to RRU2 is delayed in its TX FIFO buffer for a transmit alignment delay that is twice as long as the delay time in the RRU1 FIFO. There is no delay in the FIFO buffer for RRU3. As a result, all of the transmit data arrives at each RRU and is transmitted to the UE at the same time facilitating reception in the UE receiver, i.e., “transmit alignment.” For this example, the downlink air interface traveling time from RRU to UE, the response time in the UE, the uplink air interface traveling time from UE to RRU are all assumed to be the same.

The goal is the same in the uplink direction. The UE's response data from each of the RRUs are received in their respective receive (RX) FIFOs after traversing their three respective OILs. The delay introduced by each of the RX FIFO buffers is the same as the delay introduced by the corresponding TX FIFO buffers for the downlink path towards the same RRU. The data from RRU1 is delayed in its RX FIFO buffer for a transmit alignment delay. The data to be sent to RRU2 is delayed in its RX FIFO buffer for a transmit alignment delay that is twice as long as the delay time in the RRU1 FIFO. There is no delay in the FIFO buffer for RRU3. As a result, all of the UE response data is sent to the main unit baseband receiver at the same time, i.e., “receive alignment.”

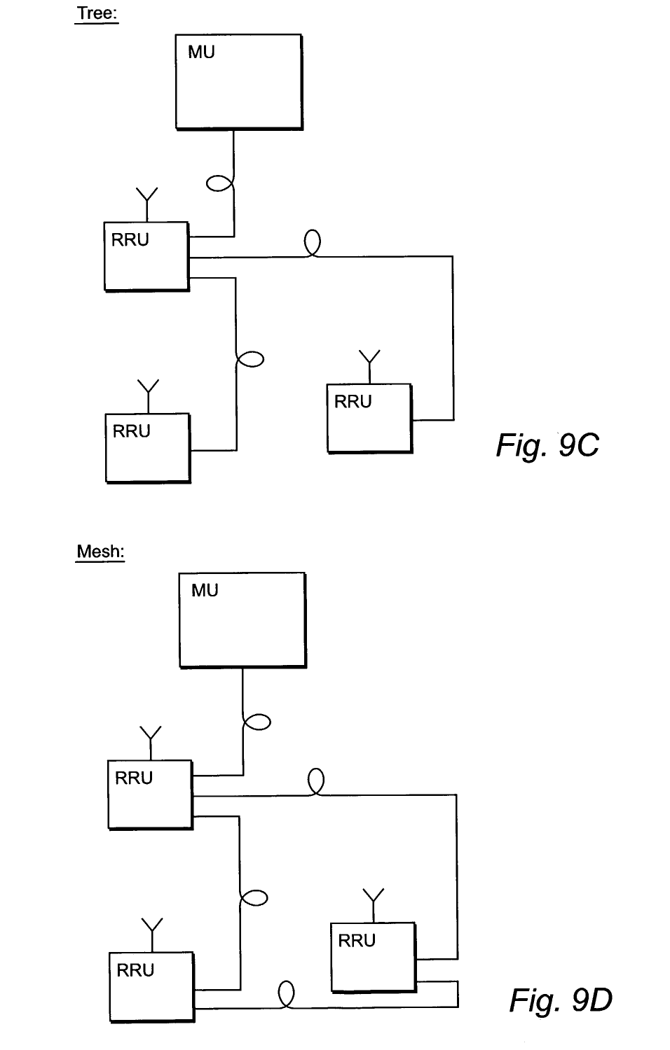

The present invention achieves standard radio base station (RBS) timing in a main-remote radio base station. FIG. 8 shows on the left simplified, standard RBS timing diagrams. A frame sync (FS) pulse marks the time when the RBS starts sending a protocol frame with the transmit (TX) data to the UE over the air interface. The UE response to the TX data starts after an air interface and UE response delay. On the right, the main-remote timing is illustrated. The frame sync is sent from the main unit to each RRU over the length-equalized OIL link in advance by twice the maximum delay shown as 2*T_OIL_MAX from the time when it would be normally be sent by a standard RBS. The transmit data frame is also sent from the main unit to each RRU over the length-equalized OIL link in advance by twice the maximum delay shown as 2*T_OIL_MAX from the time when it would be normally be sent by a standard RBS. The RRU receives the frame sync and transmit data in advance by the maximum delay shown as T_OIL_MAX. After the air interface and UE response time, which is the same as in the normal case shown on the left side, the RRU sends the UE response over the RRU's OIL. After passing through the RX FIFO buffers, all data frames are aligned and reach the uplink baseband processing circuitry at the correct timing referenced by the unshifted frame sync signal.

Advancing the frame sync and data sending time compensates for the OIL delays in a main-remote design. The FIFO buffer depth control described above equalizes the OIL delay differences. Each RRU sends the transmit data to the UE at the same time, and the UE response data is received in the receiver at the same time. In this way, a main-remote base station can function just like a standard base station.

Instead of providing an advanced timing reference to the baseband transmitters so that the downlink data is sent early towards the radio remote unit, a delayed timing reference may be provided to the baseband receivers. In that case, the unshifted frame sync signal is used as a timing reference for the baseband transmitters. Thus, the OIL link equalization may be used with advanced transmitter timing or delayed receiver timing.

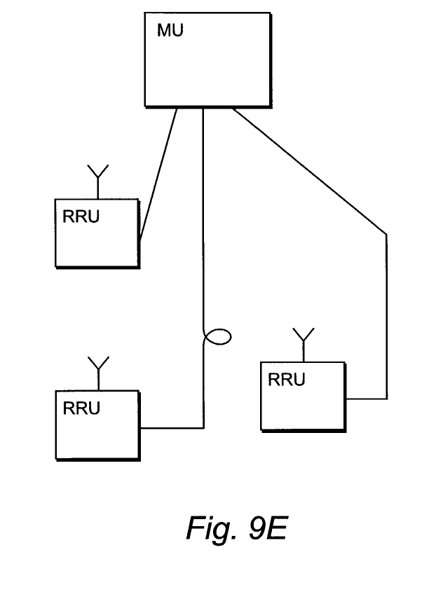

Even though the present invention is described in terms of point-to-point channels between the main unit and each RRU, either by a dedicated fiber or a dedicated wavelength by wavelength division multiplexing (WDM), the delay compensation and equalization technique can be deployed in various network topologies. FIGS. 9A-9E show simplified forms of the cascade, ring, tree, star, and mesh topologies, respectively. These network topologies relate to the physical rather than the logical architecture. In other words, when RRU's are deployed along a multi-fiber cable that loops back to the MU, it is called a ring architecture even if each RRU has it's own fiber(s) in that cable, i.e., a logical tree architecture. Consequently, the delay measurement and compensation described above works for all network scenarios.

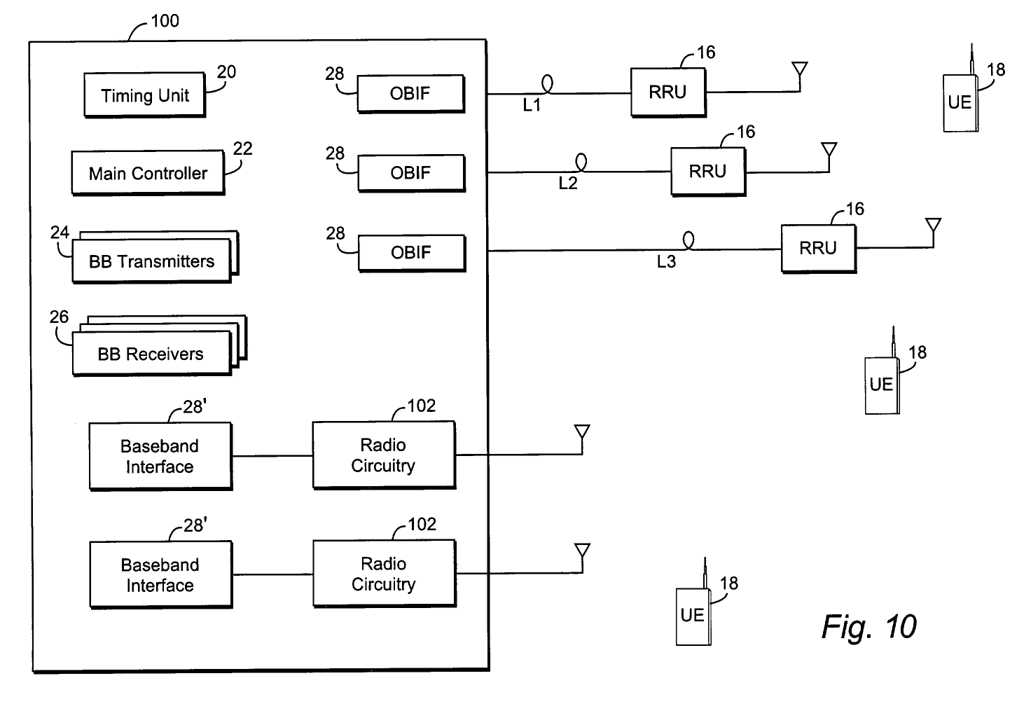

Another example embodiment of the invention illustrated in function block format in FIG. 10 incorporates a main-remote base station with a conventional base station in what is referred to as a hybrid base station 100. The hybrid base station 100 includes conventional base station circuitry incorporating elements of the main unit 12 shown in FIG. 2. Three representative remote units are shown with each RRU 16 having its own antenna, optical link L, and OBIF 28. Each conventional base station radio circuitry 102 is referred to as a “near” radio unit and is coupled to a corresponding baseband interface unit 28′. The near radio circuitry 102 is similar to the RRU circuitry 16 (e.g., transceiver, power amplifier, duplex filter, low noise amplifier, antenna, etc.), with the exception of an OBIF 30. No optical link L couples the radio circuitry 102 with the baseband transmitters 24 or baseband receivers 26, so there is no need for an OBIF 30. But there is still a need for synchronization between the different radio units. The conventional and main-remote portions of the hybrid base station should be synchronized in order to support softer handover between the near radio units 102 and the remote radio units 16 and possibly to fulfill timing requirements imposed by cellular communications standards like 3GPP.

In accordance with this aspect of the invention, each conventional base station radio circuitry 102 is treated like an RRU with a link length of zero corresponding to no link delay. Each near radio unit 102 is associated with a baseband interface 28′ that provides the maximum buffering time using, for example, the transmit and receive FIFOs and frame sync advance approach described above. The buffering and frame sync advance ensures that all of the signals received from both near and remote antennas can be readily combined in a rake receiver. No round trip delay measurement is needed for near radio units because the zero round trip delay is already known. Synchronization between near and remote radio units in a hybrid base station allows existing base stations to be enhanced with RRUs without having to significantly alter the conventional base station or alter its timing.

While the present invention has been described with respect to particular embodiments, those skilled in the art will recognize that the present invention is not limited to these specific exemplary embodiments. Different formats, embodiments, and adaptations besides those shown and described as well as many variations, modifications, and equivalent arrangements may also be used to implement the invention. For example, while FIFO buffers were described as delay mechanisms, other delays could be used like shift registers, dual port memories with offset read/write addresses, etc. Although the invention is described using preferred embodiments, they only illustrate examples of the present invention. Accordingly, it is intended that the invention be limited only by the scope of the claims appended hereto.

What is claimed is:

1. A main-remote radio base station system, comprising:
plural remote radio units each having a remote digital interface unit supporting a digital interface that includes a digital data channel and a digital timing channel;
a main unit having a main digital interface unit supporting the digital interface; and
different length links, each link coupling one of the remote radio units and the main unit and having a delay associated with its length;
wherein the main digital interface unit includes for each remote radio unit:
a delay detector for determining for each remote radio unit the delay associated with that remote radio unit's link, and
a timing compensator for compensating the delay associated with that remote radio unit's link by advancing a time when a timing signal is sent over the digital timing channel and a data signal is sent over the digital data channel.

2. The main-remote radio base station system in claim 1, wherein the delay associated with that remote radio unit's link corresponds to half the time for the timing signal to travel over the digital timing channel from the main unit and return from the remote unit.

3. The main-remote radio base station system in claim 2, wherein the delay detector is configured to determine the delay associated with that remote radio unit's link without interrupting transmission of data over the one or more digital data channels.

4. The main-remote radio base station system in claim 3, wherein the main digital interface unit includes a timing compensation controller for receiving the delays from the delay detectors continuously, periodically, or upon request.

5. The main-remote radio base station system in claim 2, wherein the delay detector includes a counter for starting to count when a digital signal is transmitted over the digital timing channel and stopping counting when the digital signal is returned over the digital timing channel from the remote unit.

6. The main-remote radio base station system in claim 1, wherein the main unit includes a timing compensation controller configured to receive the delays from the delay detectors, select a maximum delay, and control the timing compensator for each remote radio unit to advance the time when the timing signal is sent over the digital timing channel and the data signal is sent over the one or more digital data channels to compensate for the maximum delay.

7. The main-remote radio base station system in claim 6, wherein the main unit includes for each remote radio unit a transmit buffer and a receive buffer, and wherein the timing compensation controller is configured to set a transmit time that the data signal is stored in the transmit buffer before the data signal is sent on the one or more digital data channels and to set a receive time that a responsive data signal from the remote digital interface unit is stored in the receive buffer.

8. The main-remote radio base station system in claim 7, wherein a combination of the transmit time or receive time together with the measured delay for the link equals the maximum delay.

9. The main-remote radio base station system in claim 7, wherein the timing compensation controller is configured to set the transmit time and the receive time by controlling a buffer depth of the transmit and receive buffers.

10. The main-remote radio base station system in claim 7, wherein the timing compensation controller is configured to send the data signal to the transmit buffer corresponding to each remote radio unit by twice the maximum delay in advance of a time when the data signal would be sent absent the delay associated with each optical link.

11. The main-remote radio base station system in claim 1, wherein the digital interface is a digital optical interface, and wherein the main digital interface unit and remote digital interface unit each include for each remote radio unit:
a serializer for multiplexing digital data from the digital data signal, the digital synchronization signal, and a digital control signal into a serial digital stream;
an electrical-to-optical converter for converting the serial digital stream into a corresponding optical signal transmitted over the optical link;
an optical-to-electrical converter for converting an optical signal received over the optical link into a serial digital stream; and
a deserializer for demultiplexing the serial digital stream from the optical-to-electrical converter into a digital data signal, a digital synchronization signal, and a digital control signal.

12. The main-remote radio base station system in claim 1, wherein the remote radio units may be coupled to the main unit in one of the following configurations: tree, star, cascade, ring, and mesh.

13. The main-remote radio base station system in claim 1, wherein the length of one or more of the links is on the order of meters up to 10 kilometers or more.

14. A method for automatically equalizing time delays in a main-remote radio base station system where plural remote radio units are coupled to a main unit by a corresponding link having an associated delay, wherein each of the main and remote units includes a digital interface unit with a digital data channel and a digital timing channel, comprising:
determining for each remote radio unit the delay associated with that remote radio unit's link, and
for each remote radio unit, sending a data signal over the digital data channel at an advanced time relative to a time reference so that the data signal is received at each of the remote radio units at substantially the same time despite the different delays associated with each remote radio unit's link and so that a response to the digital data signal sent by each of the remote radio units is received in the main unit at substantially the same time despite the different delays associated with each remote radio unit's link.

15. The method in claim 14, wherein the delay corresponds to half the time for the timing signal to travel over the digital timing channel from the main unit and return from the remote unit.

16. The method in claim 14, wherein the delay associated with each remote radio unit's link is determined without interrupting transmission of data over the digital data channel.

17. The method in claim 14, wherein the associated delays are determined continuously, periodically, or upon request.

18. The method in claim 14, further comprising:
from the delays associated with each link, selecting a maximum delay, and
advancing the time when the data signal is sent over the digital data channel to compensate for the maximum delay.

19. The method in claim 15, further comprising for each remote radio unit:
buffering the data signal in a transmit buffer for a transmit time before the data signal is sent on the digital data channel, and
buffering in a receive buffer a responsive data signal from the remote digital interface unit for a receive time.

20. The method in claim 19, further comprising:
setting the transmit time and receive time so that a sum of the transmit time or the receive time, and the measured delay for the link equals the maximum delay.

21. The method in claim 19, further comprising:
sending the data signal to the transmit buffer for each remote radio unit by twice the maximum delay in advance of the time reference.

22. The method in claim 14, wherein the digital interface is a digital optical interface, the method further comprising for each remote radio unit:
multiplexing the digital data signal, the digital timing signal, and a digital control signal into a serial digital stream;
converting the serial digital stream into a corresponding optical signal transmitted over the optical link;
converting an optical signal received over the optical link into a serial digital stream; and
demultiplexing the serial digital stream from the optical to electrical converter into a digital data signal, a digital timing signal, and a digital control signal.

23. The method in claim 14, further comprising:
coupling the remote radio units to the main unit in one of the following configurations: tree, star, cascade, ring, and mesh.

24. The method in claim 14, wherein the length of one or more of the links is in the range of meters to 10 kilometers or more.

25. The method in claim 14, wherein the time reference is a frame sync signal, the method further comprising:
for each remote radio unit, sending a frame synchronization signal over the digital data channel in advance of when the frame synchronization signal would otherwise be sent so that the frame synchronization signal is received at each of the remote radio units at substantially the same time despite the different delays associated with each remote radio unit's link.

26. A hybrid radio base station, comprising:
a main base station unit including:
baseband processing circuitry, and
plural near radio units; and
plural remote radio units;
different length links, each link coupling one of the remote radio units and the main base station unit; and
plural digital interface units, one for each near and remote radio unit, coupled to the baseband processing circuitry;
wherein each near radio unit digital interface and each remote radio unit digital interface includes a timing compensator for compensating for a delay associated with that radio unit so that a signal received by one of the near radio units and the same signal received by one of the remote radio units may be synchronized for processing in the baseband processing circuitry.

27. The hybrid base station in claim 26, wherein each digital interface unit includes a digital data channel, and wherein each timing compensator is configured to compensate for the associated delay by advancing a time when a data signal is sent over the digital data channel from the main base station unit.

28. The hybrid base station in claim 26, wherein each digital interface unit includes a digital timing channel, and wherein each timing compensator is configured to compensate for the associated delay by advancing a time when a timing signal is sent over the digital timing channel from the main base station unit.

29. The hybrid base station in claim 26, wherein each remote radio unit digital interface includes a delay detector for determining for each remote radio unit the delay associated with that remote radio unit's link.

30. The hybrid base station in claim 29, wherein each delay detector is configured to determine the delay associated with that remote radio unit's link without interrupting transmission of data over the link.

31. The hybrid base station in claim 29, further comprising:
a timing compensation controller configured to receive the delays from the delay detectors, select a maximum delay, and control the timing compensator for each near and remote radio unit to compensate for the maximum delay,
wherein the delay for each of the near radio units corresponds to the maximum delay.

32. The hybrid base station in claim 29, wherein each digital interface unit includes a transmit buffer and a receive buffer, and wherein the timing compensation controller is configured to set a transmit time that a data signal is stored in the transmit buffer before the data signal is transmitted and to set a receive time that a responsive data signal from the radio unit is stored in the receive buffer.

33. The hybrid base station in claim 32, wherein the timing compensation controller is configured to set the transmit time and the receive time by controlling a buffer depth of the transmit and receive buffers.

34. The hybrid base station in claim 32, wherein the timing compensation controller is configured to send the data signal to the transmit buffer corresponding to each radio unit by twice the maximum delay in advance of a time when the data signal would be sent absent the associated delay.

35. The hybrid base station in claim 26, wherein the remote radio units may be coupled to the main base station unit in one of the following configurations: tree, star, cascade, ring, and mesh.

36. The hybrid base station in claim 26, wherein the length of one or more of the links is on the order of meters up to 10 kilometers or more.
